(19) United States
(12) Patent Application Publication
(10) Pub. No.: US 2017/0061551 A1
(43) Pub. Date: Mar. 2, 2017

(54) SOCIAL NETWORK PLATFORM THAT ENHANCES GOOD QUALITY FOOD CONSUMPTION

(71) Applicant: Bolanle Olayanju, East Brunswick, NJ (US)

(72) Inventor: Bolanle Olayanju, East Brunswick, NJ (US)

(21) Appl. No.: 15/247,212

(22) Filed: Aug. 25, 2016

Related U.S. Application Data
(60) Provisional application No. 62/212,639, filed on Sep. 1, 2015.

(51) Int. Cl. G06Q 50/00; G06Q 50/12; G06Q 30/02; G06F 19/00

(52) U.S. Cl. CPC G06Q 50/01; G06F 19/3418; G06Q 50/12; G06Q 30/0267

(57) ABSTRACT

A social network system includes at least one end user device operated via a user and having a mobile application installed thereon in connection with a server having a database over a network, each of the end user device and the server having access to a web services component; the server in communication with a health professional, a restaurant, and a food retail store, wherein the server facilitates communication among the health professional, the restaurant, the food retail store, the mobile application and the web services component; the food retail store connected to a coupon generator for providing discounts and coupons; each of the mobile application and the web services component programmed to: connect the user with other users to create a social network; connect the user with the health professional to obtain personalized diet and nutrition advice; receive restaurant information from the restaurant; and receive the discounts and coupons.

### CROSS REFERENCE TO RELATED APPLICATIONS

This application claims the benefit of priority under 35 U.S.C. §119(e) to U.S. Provisional Patent Application Ser. No. 62/212,639, filed on Sep. 1, 2015, and titled “SOCIAL NETWORK SYSTEM AND METHOD FOR DIET,” the entire disclosure of which is hereby incorporated by reference in its entirety for all purposes.

### FIELD OF THE INVENTION

The present invention relates generally to a system for diet, nutrition, and health. More particularly, the present invention is directed to a social network system and method for connecting users with health professionals while enabling users to receive support from a social network and readily exchange information.

### BACKGROUND OF THE INVENTION

Mobile clinical and health-related applications for portable electronic devices are becoming increasingly popular as smart phones and other mobile devices are becoming the default user terminal that is readily accessible to consumers. In this regard, these applications are convenient and easy to use; and individuals utilize existing applications for monitoring and improving their fitness, diet, mental health, and overall well-being, among other things.

While existing applications provide a platform for tracking clinical and health-related information, these applications lack means for connecting a user with other individuals to gain support and to exchange information, such as recipes, restaurant recommendations, and meal options. Furthermore, existing applications lack means for connecting users with certified and licensed health professionals for obtaining reliable dietary advice from nutrition experts. Therefore, there is a need in the art for a system and method for obtaining nutritional advice from nutrition experts while enabling users to stay connected within a social network to receive support and exchange information.

### SUMMARY OF THE INVENTION

The present system provides a plurality of data enabled devices in connection with at least one server over a network such as the Internet and LAN. Each of the devices is configured to access a website, a web application, and/or other web services. Alternatively, each of the devices includes a mobile application installed thereon.

The website, the web application, and/or the mobile application allow users to virtually connect with other users and nutritionists, dietitians, bloggers, and other health professionals to obtain advice and share information about diet, nutrition, overall health and wellness, and disease prevention and management. In this way, users can receive tailored and personalized nutrition tips and advice based on their personal goals.

Users can create a social network of friends and other users by connecting with other users on an individual basis or by joining a group, i.e., private or public groups. The users can then share and exchange various information such as meal recipes and coupons for food with other users. The website, the web application, and/or the mobile application also allow users to provide and receive recommendations on restaurants and obtain information on meal choices from the restaurants.

### BRIEF DESCRIPTION OF THE DRAWINGS

FIG. 1 shows an exemplary block diagram of the present system.

### DETAILED DESCRIPTION OF THE INVENTION

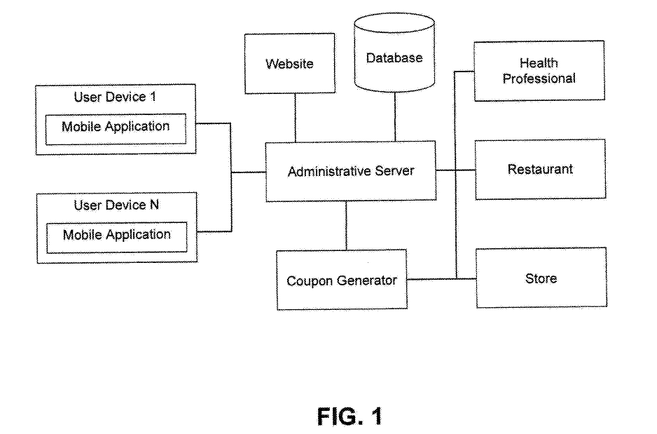

Referring now to FIG. 1, there is shown an exemplary block diagram of the present system. In one embodiment, the disclosure provides a system that includes at least one end user device, wherein the end user devices are operated by users, and further wherein the end user devices includes a variety of computer systems.

Non-limiting examples of end user devices include but are not limited to a desktop computer, a laptop, a tablet computer, a personal digital assistant (PDA), a mobile phone, and an e-reader. In this regard, it is contemplated that the user devices generally include a CPU, a memory unit, at least one input/output device, and a bus, which is used to connect the aforementioned devices.

The user devices are in communication with a server, which also include a computer system that is in communication with a database and a web services component such as a website. The server is further in communication with a variety of registered providers such as licensed health professionals, wherein the registered health professionals include qualified health professionals who are licensed to practice. Additionally, the server is in communication with participating restaurants, and participating stores such as grocery stores, health food stores, food specialty stores, and food manufacturing companies. It is contemplated that the server, end user devices, and the registered providers are in communication over one or more networks such as the Internet and LAN.

The web services component includes a website and/or a web application. It is contemplated that the web services component includes a social platform means for connecting a user to other users as well as the registered health professionals. The web services component further includes a means for receiving information about a restaurant or a food store. More specifically, and without limitation, the web services component can obtain information about the type of food that a restaurant offers, the selection of food that a store has, special offers such as coupons and promotions, or announcements for availability of food selections. The web services component may also communicate with the server e.g., to receive information and update information about restaurants, stores, and for communicating with registered health professionals within the system.

Each of the devices can be configured to access a website, a web application, and/or other web services. Alternatively, each of the devices includes a mobile application installed thereon. In one embodiment, the website, the web application, and/or the mobile application allow users to virtually connect with other users, e.g., “friending” other users, so as to create a social network. Users can create and/or join groups, wherein the groups may be public or private groups. The groups may be organized by interests, locations, and other categories so as to allow the users to connect with other users in an organized manner.

The users can then share and exchange various information such as meal recipes with other users. The meal recipes may be generated by the users and/or uploaded from a third party source such as food blogs and cooking websites. In some embodiments, the disclosure provides a means for providing coupons for ingredients in the recipe. In this regard, the server communicates with a database where coupons and promotional materials from companies are stored. The server then sorts through the database to provide the users with the promotional materials and integrates these materials into the content, i.e., meal recipes that the user has created.

When the user uploads a recipe containing one or more ingredients that are for discount and/or for sale, the application automatically associates the discount and/or coupon with the recipe. If the recipe is shared with other users, the discount and/or coupon is automatically transmitted with the recipe.

In one embodiment, the disclosure provides an interactive system and method for obtaining information about nearby points of interest (PO).

The present system provides a user interface (UI) that displays a map. In an embodiment, the map comprises a plurality of flags or similar icons that indicate location of restaurants and other food businesses in proximity to a user. The flags are color-coded depending on several factors. For example, the flags may be color-coded based on its popularity.

In some embodiments, the restaurants can be filtered so that only certain types of restaurants are displayed (i.e., via flags). For instance, restaurants can be filtered by type of cuisine, rating, distance, atmosphere, and price range, among others.

Additionally, the flags can be activated via clicking or tapping. When activated, the flags may expand a window that provides more information about the restaurant to which it is related.

For example, the window may comprise some or all menu items, the restaurant's website, the restaurant's phone number, and ratings. The window can be displayed over the map so that the user need not navigate from a page to a page and all of the information is centrally located on one page.

Additionally, the website, the web application, and/or the mobile application allow the users to seek guidance and advice from registered nutritionists, dietitians, and other health professionals regarding diet, nutrition, overall health and wellness, and disease prevention and management. As described above, the health professionals include individuals who are certified and licensed to practice and treat the users. The users can work with the health professionals on a one-on-one basis in order to consult with them and to receive tailored and personalized nutrition tips and advice based on the users' personal goals.

The website, the web application, and/or the mobile application also allow users to provide and receive recommendations on restaurants and obtain information on meal choices from the restaurants. The users can visit and/or follow or subscribe to various restaurants that are registered in the system. When a restaurant is mentioned on a user's feed or bulletin board within the mobile application, a link for obtaining additional information about the restaurant is automatically generated with the feed. Without limitation, the information includes a list of menu items, hours of operation, location, and rating. It is contemplated the information in the link is uploaded by the associated restaurant or imported from the restaurant's website.

The registered restaurants can also create a page on the website, the web application, and/or the mobile application, wherein the page can contain information about the menu items at the restaurant. Each of the menu items may be described in detail so as to list each of the ingredients, options for recipe substitutions, and nutrition facts.

Furthermore, the page can describe information regarding cooking practices and kitchen facility information so as to warn and/or notify the users of any possible cross contamination. This is particularly advantageous when a user has a diet restriction, allergies, disease, or other health concerns. In this regard, the present disclosure allows users to become more informed and prepared while dining in public.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A social network system, comprising:
at least one end user device in connection with a server over a network, wherein the at least one end user device is operated via a user;
the at least one end user device having a mobile application installed thereon;
each of the end user device and the server having access to a web services component;
the server having a database and in communication with a health professional, a restaurant, and a food retail store, wherein the server facilitates communication among the health professional, the restaurant, the food retail store, the mobile application and the web services component;
the food retail store connected to a coupon generator for providing discounts and coupons;
each of the mobile application and the web services component programmed to:
connect the user with other users to create a social network;
connect the user with the health professional to obtain personalized diet and nutrition advice; and
receive restaurant information from the restaurant; and
receive the discounts and coupons.

2. The system of claim 1, wherein the restaurant information is updated in real-time and comprises a list of menu items and related information thereto, hours of operation of the restaurant, and location of the restaurant.

3. The system of claim 1, wherein each of the mobile application and the web services component comprises private or public social groups.

4. The system of claim 1, wherein each of the mobile application and the web services component comprises a messaging module for transmitting meal recipes, or the discounts and the coupons.

5. The system of claim 1, wherein the at least one user device is data enabled and is configured to allow the user to check in at the restaurant via the mobile application and the web services component.

6. A computer-implemented method of social networking, comprising the steps of:
creating a user account on a mobile application and a web services component;
registering a health professional selected from a licensed dietitian, a nutritionist, a medical doctor, or a therapist; and
connecting the user account with the health professional via the mobile application and the web services component so as to enable the user to receive advice on diet and nutrition from the health professional.

7. The method of claim 6, further comprising registering a restaurant for transmitting restaurant information to the mobile application and the web services component.

8. The method of claim 6, further comprising registering a food retail store for transmitting discounts and coupons for food items to the mobile application and the web services component.

9. The method of claim 8, further comprising transmitting user generated or third party source meal recipes to the mobile application and the web services component.
